(19) United States
(12) Patent Application Publication
(10) Pub. No.: US 2006/0263085 A1
(43) Pub. Date: Nov. 23, 2006

(54) Method of and system for determining the performance of heterogeneous optical transmission system

(75) Inventors: Jean-Christophe Antona, Montrouge (FR); Sebastien Bigo, Massy (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/412,745

(22) Filed: Apr. 28, 2006

(30) Foreign Application Priority Data
May 17, 2005 (EP) 05291062.7

(51) Int. Cl. H04L 12/56; H04B 10/08

(52) U.S. Cl. 398/25; 370/389

(57) ABSTRACT

The present invention relates to a method of determining the performance of a heterogeneous optical transmission system, which preferably comprises wavelength division multiplexing (WDM), wherein said heterogeneous optical transmission system comprises a plurality of preferably homogenous optical transmission subsystems (i), characterized by determining a criterion (Φ) for said performance of the heterogeneous optical transmission system depending on a weighted combination of performance criteria (Φ⁽ⁱ⁾) of said optical transmission subsystems (i). The present invention further relates to a system for determining the performance of a heterogeneous optical transmission system comprising wavelength division multiplexing (WDM), wherein said heterogeneous optical transmission system comprises a plurality of preferably homogenous optical transmission subsystems (i).

The invention is based on a priority application EP 05291062.7 which is hereby incorporated by reference.

### FIELD OF THE INVENTION

The present invention relates to a method of determining the performance of a heterogeneous optical transmission system, which preferably comprises wavelength division multiplexing (WDM), wherein said heterogeneous optical transmission system comprises a plurality of optical transmission subsystems.

### BACKGROUND OF THE INVENTION

The present invention further relates to a system for determining the performance of a heterogeneous optical transmission system, which preferably comprises wavelength division multiplexing (WDM), wherein said heterogeneous optical transmission system comprises a plurality of optical transmission subsystems.

Methods and systems for assessing the performance of WDM optical transmission systems are per se known from prior art and are used to determine the haul of the system and the required number of amplifiers or OEO (optical-electrical-optical) regenerators.

However, present solutions do not provide for precise performance assessment of heterogeneous WDM transmission systems, i.e. comprising various subsystems each of which uses another type of optical fiber or another fiber length and the like. The lack of accuracy when assessing heterogeneous WDM transmission systems can lead to severely misestimate the haul of the heterogeneous WDM transmission system which results in using too many e.g. OEO regenerators when overestimating system impairments. On the other hand, when underestimating system impairments due to the present solutions' lack of accuracy, this may lead to providing optical links that are not physically feasible.

### SUMMARY OF THE INVENTION

Consequently, it is an object of the present invention to provide an improved method of and system for determining the performance of a heterogeneous optical transmission system, which overcomes the disadvantages of prior art.

According to the present invention, regarding the above mentioned method this object is solved by determining a criterion for said performance of the heterogeneous optical transmission system depending on a weighted combination of performance criteria of said optical transmission subsystems.

This enables to increase the method's accuracy by selectively considering e.g. a plurality of performance criteria wherein each of said performance criteria so considered relates to one of the subsystems comprised within the heterogeneous optical transmission system.

According to an advantageous embodiment of the present invention, a nonlinear accumulated phase is used as a performance criterion and/or a performance criterion which is proportional to the nonlinear accumulated phase. This performance criterion—as well as other possible performance criteria—may be applied to each of the subsystems of the heterogeneous optical transmission system as well as to the heterogeneous optical transmission system directly. I.e., the performance of a subsystem may be expressed by the nonlinear accumulated phase as well as the performance of the whole heterogeneous optical transmission system comprising a plurality of subsystems.

The performance criterion directed to the nonlinear accumulated phase is e.g. described in: ANTONA, J.-C., BIGO, S., and FAURE, J.-P.: ‘Nonlinear cumulated phase as a criterion to assess performance of terrestrial WDM systems’. Proc. OFC'2002, Anaheim, Calif., USA, WX5, pp. 365-367.

A performance criterion proportional to a sum of the input power applied to each fiber of an optical transmission subsystem may also be used as a performance criterion.

A further embodiment of the inventive method uses a performance criterion proportional to
(a) a sum over the different fiber spans of said subsystem, and/or
(b) a sum of an input power applied to each fiber span, divided by the effective area of the fiber span, and/or multiplied by a non-linear index the fiber, and/or multiplied by the effective length of the fiber span.

It is also possible to use a performance criterion proportional to a number of fiber spans of said subsystem.

A further very advantageous embodiment of the present invention is characterized by determining said performance criterion as a weighted sum of respective performance criteria of two or more subsystems. Weighting the performance criteria of the subsystems enables to account for different properties of the respective subsystems comprised within said heterogeneous optical transmission system and is far more predictive than prior art methods.

Yet another very advantageous embodiment of the present invention proposes using weighting factors for weighting said performance criteria of said two or more subsystems, wherein said weighting factors depend on non-linear thresholds which correspond to a tolerance to nonlinear effects of the respective subsystem. For instance, the non-linear threshold can refer the value of the performance criterion corresponding to a given tolerable amount of signal distortion, for instance a given amount of penalty, i.e. on an eye opening or on a required OSNR to get a given Bit Error Rate (BER) as defined in the abovementioned article.

According to another embodiment of the present invention, said weighting factors are the inverse of said non-linear thresholds of said subsystem.

According to a further embodiment of the present invention, said non-linear thresholds depend on a fiber dispersion and/or a length of an optical fiber of the respective subsystem and/or attenuation, effective area, non-linear index, a size of the subsystem, a type of a dispersion compensating module used, depending on the chosen criterion.

The non-linear thresholds can e.g. be obtained by means of measurement and/or interpolation.

According to another advantageous embodiment of the present invention, said subsystems comprised within said heterogeneous optical transmission system comprise different sizes, different types of optical fibers and/or different span lengths or numbers of spans.

A further solution to the object of the present invention is given by a system for determining the performance of a heterogeneous optical transmission system comprising wavelength division multiplexing (WDM) which contains means for determining a criterion for said performance of the heterogeneous optical transmission system depending on a weighted combination of performance criteria of said optical transmission subsystems.

The inventive method may e.g. be implemented by using a computer system and may also be included to existing optical transmission system design tools.

### BRIEF DESCRIPTION OF THE DRAWINGS

Further advantages and features of the present invention are given in the following detailed description with reference to the drawings, in which

FIG. 1 depicts a diagram showing the OSNR (optical signal-to-noise ratio) penalty as a function of a prior art performance criterion, and

FIG. 2 depicts a diagram showing the OSNR penalty as a function of a criterion provided by the present invention.

### DETAILED DESCRIPTION OF THE INVENTION

Within a first embodiment of the present invention, a criterion Φ directed to the nonlinear accumulated phase, which is e.g. described in: ANTONA, J.-C., BIGO, S., and FAURE, J.-P.: ‘Nonlinear cumulated phase as a criterion to assess performance of terrestrial WDM systems’. Proc. OFC'2002, Anaheim, Calif., USA, WX5, pp. 365-367, is used to assess the performance of a heterogeneous optical transmission system comprising wavelength division multiplexing (WDM).

Said heterogeneous transmission system consists of N many subsystems i=0, . . . , N−1, each of which can be characterized by a respective performance criterion Φ⁽ⁱ⁾ describing the nonlinear accumulated phase of the respective subsystem i. That is, the performance criterion of the second subsystem (i=1) is denoted as Φ⁽¹⁾, and so on.

According to the present invention, the overall performance of the heterogeneous optical transmission system described by the performance criterion Φ is determined according to

$$Φ = {\sum }_{i = 0}^{N - 1} {C}^{( i )} {Φ}^{( i )} .$$

I.e., the performance criterion Φ describing the overall performance of the heterogeneous optical transmission system comprising the N many subsystems is a weighted sum of the performance criteria Φ⁽ⁱ⁾ describing the nonlinear accumulated phase of the respective subsystem i.

The weighting factors C⁽ⁱ⁾ depend on non-linear thresholds which correspond to a tolerance to nonlinear effects of the respective subsystem. Said non-linear thresholds e.g. depend on a fiber dispersion and/or a length of an optical fiber and the spacing between two consecutive nodes in a network environment (along with a dependence on the bit rate, a channel spacing, and a modulation format) of the respective subsystem i and they can be determined by means of measurement and/or by interpolation.

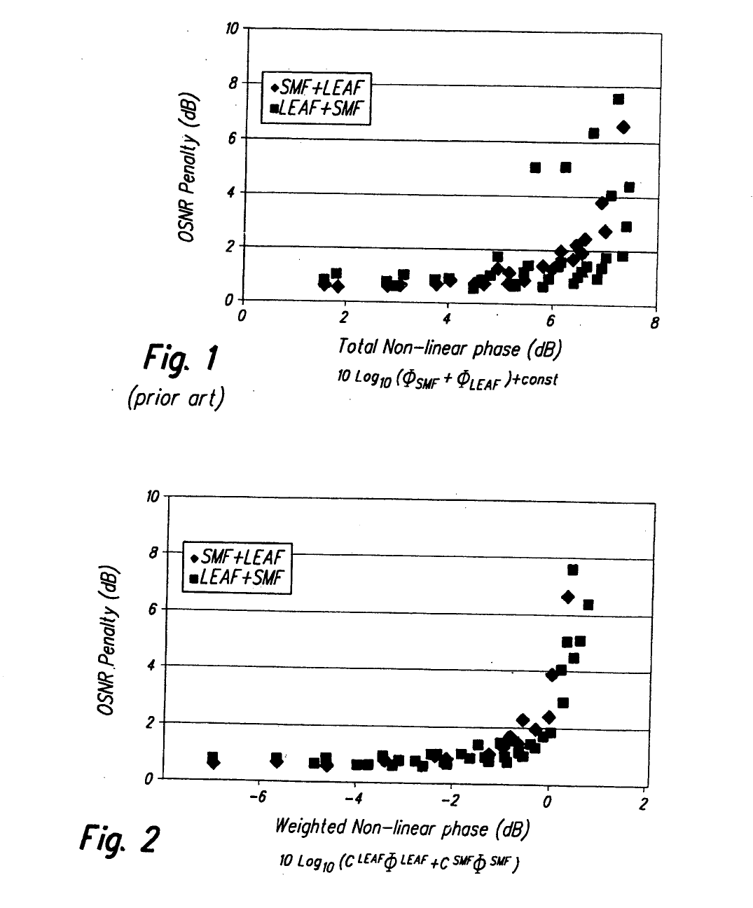

FIG. 1 depicts a diagram showing the OSNR (optical signal-to-noise ratio) penalty of a heterogeneous optical transmission system comprising two subsystems, wherein the OSNR is given depending on a performance criterion of an accumulated non-linear phase obtained by using a prior art method. More precisely, the OSNR penalty of FIG. 1 is defined as the differential required OSNR at a receiver end to get a given bit error rate (BER) of 10ˆ(−5) between systems with or without propagation over the link, the reference being with a transmitter and a receiver in a back to back configuration.

The first subsystem comprises a standard single mode optical fiber (SMF), whereas the second subsystem comprises a LEAF-type optical fiber (LEAF).

As can be gathered from the diagram of FIG. 1, the prior art method for determining the performance of said heterogeneous optical transmission system comprising two subsystems SMF, LEAF yields different results for the OSNR penalty depending on the sequence of the two subsystems. That is, the relationship between the OSNR penalty due to non-linear effects and the performance criterion according to prior art
Φ=Φ_{SMF}+Φ_{LEAF}
is not bi-univocal. Said prior art criterion does therefore not allow to precisely assess the performance of the given heterogeneous optical transmission system comprising two subsystems SMF, LEAF.

In contrast, when using the inventive method providing for a weighted sum of the performance criteria Φ_{SMF}, Φ_{LEAF} of said subsystems SMF, LEAF, the inventive performance criterion for the heterogeneous optical transmission system comprising said two subsystems SMF, LEAF is obtained as follows:

$$Φ = {\sum }_{i = 0}^{1} {C}^{( i )} {Φ}^{( i )} = {C}^{LEAF} {Φ}^{LEAF} + {C}^{SMF} {Φ}^{SMF} .$$

When using said inventive method to obtain the performance criterion Φ, the relationship between the OSNR penalty due to non-linear effects and the inventive performance criterion Φ is substantially bi-univocal, cf. FIG. 2, since basically the same values of OSNR penalty are obtained for different values of the inventive performance criterion Φ, regardless the sequence of the subsystems SMF, LEAF.

The weighting factors C^{LEAF}, C^{SMF} depend on non-linear thresholds which correspond to a tolerance to nonlinear effects of the respective subsystem LEAF, SMF. Said non-linear thresholds e.g. depend on a fiber dispersion and/or a length of an optical fiber of the respective subsystem i and they can be determined by means of measurement and/or by interpolation.

By using the inventive method it is possible to accurately determine the performance of a heterogeneous optical transmission system comprising a plurality of subsystems which enables to design such a heterogeneous optical transmission system to the lowest cost.

The inventive method can be used to assess the performance of heterogeneous optical transmission systems comprising a plurality of different subsystems each of which exhibits different properties regarding the optical fiber used such as e.g. a dispersion, a length and the like.

It is also possible to generalize the inventive idea of providing a weighted combination of performance criteria to other performance criteria than said nonlinear accumulated phase. For instance, an overall performance criterion regarding the number of optical fiber spans or the sum of input powers applied to fiber sections, or the sum of input powers applied to fiber sections, weighted by effective areas and/or non-linear indexes, and/or effective lengths, may also be obtained by providing a weighted sum of individual subsystems' performance criteria, wherein weighting factors may e.g. depend on dispersion and/or span length and the like.

1. Method of determining the performance of a heterogeneous optical transmission system, which preferably comprises wavelength division multiplexing, wherein said heterogeneous optical transmission system comprises a plurality of optical transmission subsystems, said method comprising the step of determining a criterion for said performance of the heterogeneous optical transmission system depending on a weighted combination of performance criteria of said optical transmission subsystems.

2. Method according to claim 1, comprising the step of using a nonlinear accumulated phase as a performance criterion and/or a performance criterion which is proportional to the nonlinear accumulated phase.

3. Method according to claim 1, comprising the step of using a performance criterion proportional to a sum of the input power applied to each fiber of an optical transmission subsystem.

4. Method according to claim 1, comprising the step of using a performance criterion proportional to a sum over the different fiber spans of said subsystem a sum of an input power applied to each fiber span, divided by the effective area of the fiber span, and/or multiplied by a non-linear index of the fiber, and/or multiplied by the effective length of the fiber span.

5. Method according to claim 1, comprising the step of using a performance criterion proportional to a number of fiber spans of said subsystem.

6. Method according to claim 1, comprising the step of determining said performance criterion as a weighted sum of respective performance criteria of two or more subsystems.

7. Method according to claim 6, comprising the step of using weighting factors for weighting said performance criteria of said two or more subsystems, wherein said weighting factors depend on non-linear thresholds which correspond to a tolerance to nonlinear effects of the respective subsystem.

8. Method according to claim 7, wherein said weighting factors are the inverse of said non-linear thresholds of said subsystem.

9. Method according to claim 7, wherein said non-linear thresholds depend on a fiber dispersion and/or a length of an optical fiber of the respective subsystem.

10. Method according to one of the claims 7, wherein said non-linear thresholds depend on the number of fibers of the respective subsystem.

11. Method according to one of the claims 7, wherein said non-linear thresholds depend on a dispersion management scheme of the respective subsystem.

12. Method according to one of the claims 7, wherein the non-linear thresholds are obtained by means of measurement and/or interpolation.

13. Method according to claim 1, wherein said subsystems comprised within said heterogeneous optical transmission system comprise different types of optical fibers and/or different span lengths.

14. Method according to claim 1, wherein said subsystems comprised within said heterogeneous optical transmission system are separated by optical nodes.

15. System for determining the performance of a heterogeneous optical transmission system, which preferably comprises wavelength division multiplexing, wherein said heterogeneous optical transmission system comprises a plurality of preferably homogenous optical transmission subsystems, said system comprises means for determining a criterion for said performance of the heterogeneous optical transmission system depending on a weighted combination of performance criteria of said optical transmission subsystems.
